(19) United States
(12) Patent Application Publication
(10) Pub. No.: US 2013/0213631 A1
(43) Pub. Date: Aug. 22, 2013

(54) AIR CONDITIONER FOR VEHICLE

(71) Applicant: DENSO CORPORATION, (US)

(72) Inventors: Yoshinori Ichishi, Kariya-city (JP); Yasushi Kondo, Aichi-gun (JP); Yoshinori Yanagimachi, Takahama-city (JP); Satoshi Izawa, Chiryu-city (JP)

(73) Assignee: DENSO CORPORATION, Kariya-city (JP)

(21) Appl. No.: 13/770,325

(22) Filed: Feb. 19, 2013

(30) Foreign Application Priority Data
Feb. 21, 2012 (JP) 2012-035428

(51) Int. Cl. B60H 1/00

(52) U.S. Cl. CPC B60H 1/00021
USPC 165/202; 454/75

(57) ABSTRACT

An air conditioner for a vehicle equipped with a battery includes an air conditioning unit, and a control unit. The air conditioning unit performs air-conditioning of the vehicle compartment and the control unit controls operation of the air conditioning unit. The control unit restricts the operation of the air conditioning unit when the remaining battery capacity is less than or equal to a predetermined value. Thus, it is possible to ensure running safety while passenger thermal comfort can be improved.

### CROSS REFERENCE TO RELATED APPLICATION

This application is based on Japanese Patent Application No. 2012-35428 filed on Feb. 21, 2012, the disclosure of which is incorporated herein by reference.

### TECHNICAL FIELD

The present disclosure relates to a vehicle air conditioner for a vehicle compartment.

### BACKGROUND

Conventionally, an air conditioner for a vehicle is known, and Patent Document 1 (Japanese Patent No. 3493238) discloses such an air conditioner. The vehicle air conditioner of the Patent Document 1 discloses a vehicle with an electric motor for traveling. When the remaining battery capacity for the electric motor falls, battery power consumption of the air conditioner is controlled to be low by lowering a rotational speed of a compressor, or the operation of the air conditioner is controlled to be stopped.

In the Patent Document 1, when power consumption becomes low, a rotational speed of a compressor is controlled to be decreased and a rotational speed of an outside motor fan is controlled to be increased in order to prevent from stopping the temperature sensitivity of passengers from deteriorating or the vehicle from stopping before the vehicle reaches the destination.

However, in an environment where the outside air temperature is low, there may be a matter of the above-mentioned low power consumption of the air conditioner. In particular, when the performance of the air conditioner declines, this causes windshields to fog, thereby affecting safety of the vehicle, and deterioration of the temperature sensitivity of passengers.

### SUMMARY

In view of the foregoing matters, it is an object of the present disclosure to provide an air conditioner for a vehicle, which can ensure running safety, and improve passenger thermal comfort.

According to an aspect of the present disclosure, an air conditioner for a vehicle equipped with a battery includes, an air conditioning unit, and a control unit. The battery supplies electrical power to an electrical motor. The air conditioning unit performs air-conditioning in a passenger compartment, and the control unit controls operation of the air conditioning unit and sets an air outlet mode among multiple air outlet modes including a defroster mode in which air conditioned by the air conditioning unit flows forward a front windshield of the vehicle.

The control unit stops the operation of the air conditioning unit in an air outlet mode other than the defroster mode and is capable of only setting a defroster mode when a remaining capacity of the battery is less than or equal to a predetermined remaining capacity.

According to another aspect of the present disclosure, an air conditioner for a vehicle equipped with a battery includes an air conditioning unit, a seat air conditioning unit, and a control unit. The battery supplies electrical power to an electrical motor. The air conditioning unit performs air-conditioning in a passenger compartment, the seat air conditioning unit adjusts a temperature of a seat of the vehicle, and the control unit controls operation of the air conditioning unit and the seat air conditioning unit. The control unit operates the seat air conditioning unit while stopping operation of the air conditioning unit when a remaining capacity of the battery is less than or equal to a predetermined value.

According to another aspect of the present disclosure, an air conditioner for a vehicle equipped with a battery includes an air conditioning unit, a seat air conditioning unit, and a control unit. The battery supplies electrical power to an electrical motor. The air conditioning unit performs air-conditioning in a passenger compartment, the seat air conditioning unit adjusts a temperature of a seat of the vehicle, and the control unit controls operation of the air conditioning unit and the seat air conditioning unit. The control unit operates the seat air conditioning unit to control temperature of the seat while stopping operation of air-conditioning when a remaining capacity of the battery is less than or equal to a predetermined value and the seat air conditioning unit is turned on.

According to another aspect of the present disclosure, an air conditioner for a vehicle equipped with a battery includes, an air conditioning unit, and a control unit. The battery supplies electrical power to an electrical motor. The air conditioning unit performs air-conditioning in a passenger compartment, and the control unit controls operation of the air conditioning unit. The control unit controls an air introduction mode between an outside air introduction mode in which air outside of the passenger compartment is introduced into the air conditioning unit and an inside air circulation mode in which air inside of the passenger compartment is introduced, and the control unit switches to the outside air introduction mode while stopping operation of the air conditioning unit when a remaining capacity of the battery is less than or equal to a predetermined value.

In the air conditioner for a vehicle according to any one aspect of the present disclosure, it is possible to ensure running safety while passenger thermal comfort can be improved.

### BRIEF DESCRIPTION OF THE DRAWINGS

The disclosure, together with additional objectives, features and advantages thereof, will be best understood from the following description, the appended claims and the accompanying drawings in which:

FIG. 1 is a schematic diagram of an air conditioner for a vehicle, according to a first embodiment of the disclosure;

FIG. 2 is a schematic diagram of a frame format of the configuration of an electric heater at the first embodiment;

FIG. 3 is a schematic diagram of an electrical configuration of an air conditioner for a vehicle, according to the first embodiment of the disclosure;

FIG. 4 is a flowchart of a subroutine control process performed by an air conditioning ECU;

FIG. 5A is a flowchart of a subroutine of control process of FIG. 4;

FIG. 5B, 5C, 5D are charts used as an example in FIG. 5A;

FIG. 6A is a flowchart of a subroutine of control process of FIG. 4;

FIG. 6B is a chart used as an example in FIG. 6A;

FIG. 7 is a flowchart of a subroutine of control process of FIG. 4;

FIG. 8 is a flowchart of a subroutine of control process of FIG. 4;

FIG. 9A is a flowchart of a subroutine of control process of FIG. 4;

FIG. 9B is a chart used as an example in FIG. 9A;

FIG. 10A is a flowchart of a subroutine of control process of FIG. 4;

FIG. 10B is a chart used as an example in FIG. 10A;

FIG. 11A is a flowchart of a subroutine of control process of FIG. 4;

FIG. 11B, 11C, 11D, 11E, 11F are charts used as an example in FIG. 11A;

FIG. 12 is a flowchart of a subroutine of control process of FIG. 4;

FIG. 13 is a flowchart of a subroutine of control process of FIG. 4;

FIG. 14 is a schematic diagram of an air conditioner for a vehicle, according to a second embodiment of the disclosure;

FIG. 15 is a schematic diagram of an electrical configuration of an air conditioner for a vehicle according to the second embodiment of the disclosure;

FIG. 16 is a flowchart of overall control process performed by an air conditioning ECU according to the second embodiment of the disclosure;

FIG. 17 is a flowchart of a subroutine of control process of FIG. 16;

FIG. 18 is a graph to determine seat temperature regulating level of a seat air conditioning unit;

FIG. 19 is a graph of operating conditions of a seat air conditioning unit;

FIG. 20 is a diagram of order of transitions about a temperature regulating level of a seat air conditioning unit;

FIG. 21 is a flowchart of a control process performed by an air conditioning ECU, according to a third embodiment of the disclosure;

FIG. 22 is a flowchart of a subroutine of control process of FIG. 21;

FIG. 23 is a flowchart of a control process performed by an air conditioning ECU, according to a fourth embodiment of the disclosure;

FIG. 24A is a flowchart of a subroutine of control process of FIG. 23; and

FIG. 24B is a chart used as an example in FIG. 24A.

### DETAILED DESCRIPTION

Embodiments of the present disclosure will be described with reference to the drawings. In the embodiments, a part that corresponds to a matter described in a preceding embodiment may be assigned with the same numeral, and redundant explanation for the part may be omitted. When only a part of a configuration is described in an embodiment, another preceding embodiment may be combined even if it is not explicitly described that the parts can be combined. The embodiments may be partially combined even if it is not explicitly described that the embodiments can be combined, provided there is no harm in the combination.

### First Embodiment

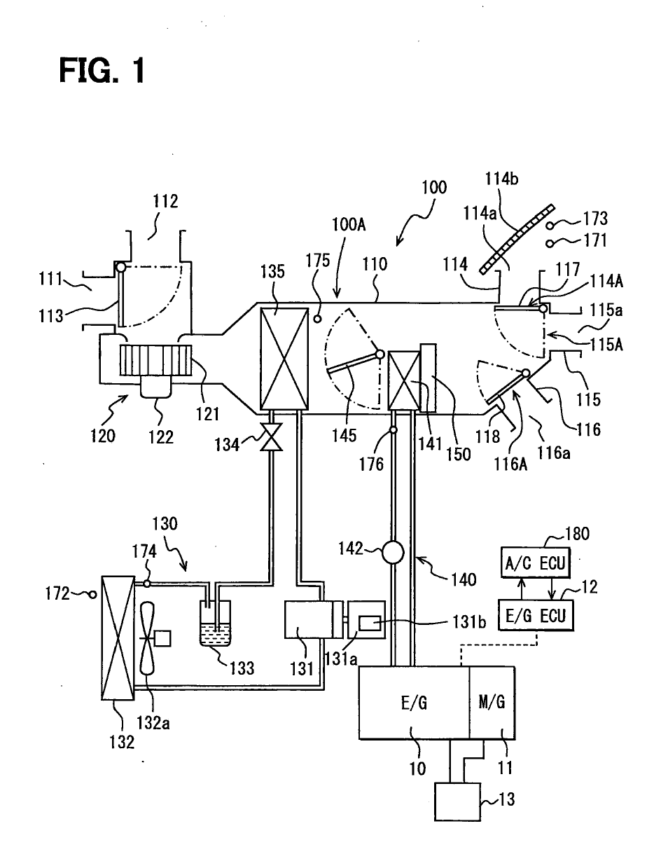

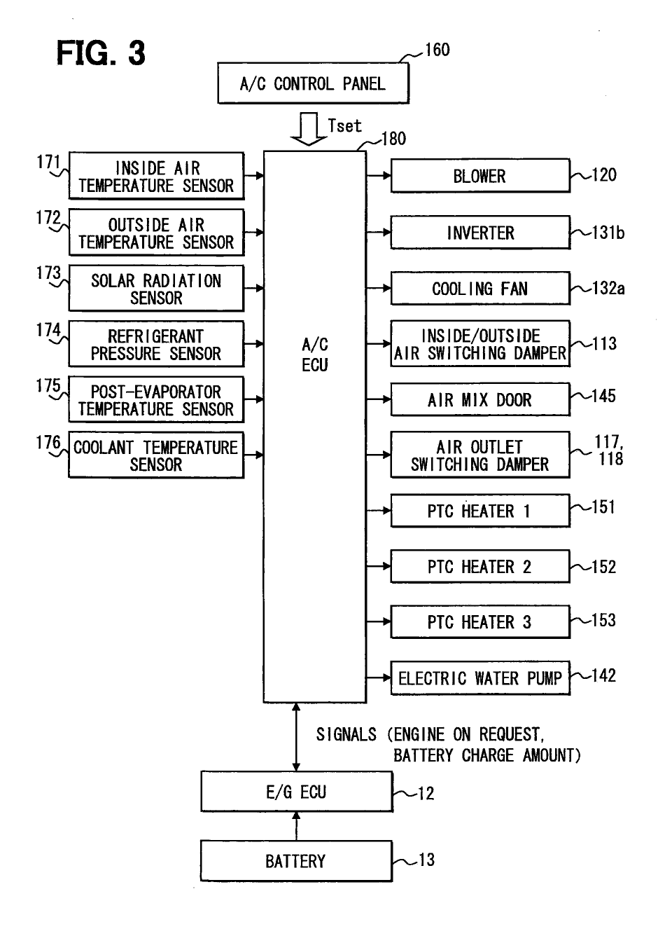

As shown in FIGS. 1 and 3, an air conditioner 100 according to a first embodiment is typically used for a vehicle, which receives a driving force from at least either an internal combustion engine (E/G) 10 for driving the vehicle or motor 11, which is an electrical motor-generator 11, for driving the vehicle.

The vehicle, which is a hybrid vehicle, includes the engine 10 (E/G), a motor 11, a hybrid ECU 12 for controlling operation of the engine 10 (an engine starter) and the motor 11, and a battery 13 for supplying electric power to various devices described later of air conditioner for a vehicle. A seat is equipped with a seat air conditioning unit controlling temperature of the seat in the vehicle. The hybrid ECU 12 can calculate remaining battery charge in the battery 13 based on an initial amount of charge in the battery 13, and an integrated value of power consumption of devices. Additionally, the hybrid ECU 12 and an air conditioning ECU 180 of the air conditioner 100 for a vehicle are interconnected by wires or other connection method with each other. The hybrid ECU 12 and the air conditioning ECU 180 can transmit and receive the input signals and calculated result one another.

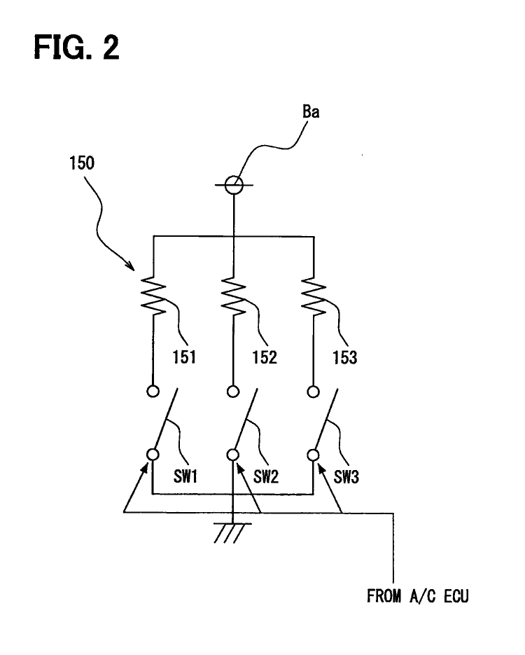

The air conditioner 100 includes an air conditioning unit 100A for controlling the condition of air inside the vehicle compartment, and the air conditioning ECU 180 controlling operation of the air conditioning unit 100A. Additionally, the air conditioning unit 100A includes an air conditioning duct 110, a blower 120, a refrigeration cycle 130, a coolant circuit 140, an air mix door 145, an electric heater 150, an air conditioner control panel 160, and multiple sensors 171 to 176 as shown in FIGS. 1 to 3.

The air conditioning duct 110 is disposed on the front side of the vehicle compartment. The air conditioning duct 110 has an air inlet switching box (inside-outside air switching box), including an air inside air inlet 111 for taking in air inside of the vehicle compartment (hereinafter referred to as an inside air), and an outside air inlet 112 for taking in air outside of the vehicle compartment (hereinafter referred to as an outside air). The air inlet switching box is provided on the uppermost stream side (windward side) of the air conditioning duct 110.

An inside-outside air switching damper 113 is rotatably attached to open and close the inside air inlet 111 and the outside air inlet 112. The inside-outside air switching damper 113 is driven by an actuator, such as a servo motor, and adapted to switch an air inlet mode among, for example, an inside air circulation (REC) mode, an inside air circulation and outside air introduction (REC/FRS) mode, and an outside air introduction (FRS) mode. The actuator of the inside-outside switching damper 113 is controlled by the air conditioner ECU 180 described later.

The air conditioning duct 110 constitutes an air outlet switching portion, and is provided with a defroster (DEF) opening 117A defined by a defroster duct 114, a face (FACE) opening 115A defined by a face duct 115, and a foot (FOOT) opening 116A defined by a foot duct 116. The air outlet switching portion is provided on the lowermost side (leeward side) of the air conditioning duct 110. The DEF opening 114A is connected with the defroster duct 114, and a defroster (DEF) air outlet 114a defined by the defroster duct 114 is opened for mainly blowing out the warm air toward the inner surface of a front windshield 114b of the hybrid vehicle at the end of the lowermost side of the defroster duct 114. The FACE opening 115A is connected to the face duct 115, and the face (FACE) air outlet 115a defined by the face duct 115 is opened for mainly blowing out the cool air to the head and chest of the passenger at the end of the lowermost side of the face duct 115. The FOOT opening 116A is connected to the foot duct 116, the foot (FOOT) air outlet 116a defined by the foot duct 116 is opened for mainly blowing out the warm air toward the foot of passenger at the end of the lowermost side of the foot duct 116.

Two air-outlet switching dampers 117, 118 are rotatably attached to the insides of respective air outlets 114a to 116a. Each of the air-outlet switching damper 117, 118 is driven by an actuator, such as a servo motor, to switch an air outlet mode among a face (FACE) mode, a bi-level (B/L) mode, a foot (FOOT) mode, a foot/defroster (FID) mode, and a defroster (DEF) mode. Each actuator of the two air-outlet switching dampers 117, 118 is controlled by the air conditioning ECU 180 described later.

The blower 120, which is arranged at a downstream side of the inside-outside air switching box, includes a centrifugal fan 121 rotatably accommodated in a scroll case integrally formed with the air conditioning duct 110, and a blower motor 122 for rotatably driving the centrifugal fan 121. The blower motor 122, which is controlled by the air conditioning ECU 180, controls an amount of blown air (a rotational speed of the centrifugal fan 121) based on a blower terminal voltage (a blower voltage) applied via a blower driving circuit.

The refrigerant cycle 130 includes a compressor 131, a condenser 132, a receiver (a liquid receiver or a gas/liquid separator) 133, an expansion valve 134, an evaporator 135, and refrigerant pipes. The compressor 131 compresses the refrigerant. The condenser 132 cools and liquefies the compressed refrigerant. The receiver 133 separates the condensed and liquefied refrigerant into vapor and liquid phases and for allowing only the liquid refrigerant to flow to the downstream side. The expansion valve 134 decompresses and expands the liquid refrigerant. The evaporator 135 evaporates and gasifies the decompressed and expanded refrigerant. The refrigerant pipes connect these elements in an annular shape.

The compressor 131 is an electric compressor driven by a motor 131a. The operating frequency of the motor 131a is controlled by an inverter 131b. The condenser 132 is an exterior heat exchanger for transferring heat from refrigerant flowing therein to running air caused by the running of the hybrid vehicle and outside air blown by a cooling fan 132a. The condenser 132 is disposed at a position where it easily receives running air. The evaporator 135 is an interior heat exchanger that performs an air cooling operation for cooling air passing therethrough and a dehumidifying operation for dehumidifying air passing therethrough. The evaporator 135 is disposed on a downstream side of air flow of the blower 120 to fully cover the whole air passage of the air conditioning duct 110 in a cross section. The operations of the inverter 131b and the cooling fan 132a are controlled by the air conditioning ECU 180.

The coolant circuit 140 is a circuit for circulating the coolant warmed by the water jacket of the engine 10 by use of a water pump, and includes a radiator, a thermostat, and a heater core 141.

The heater core 141 is a heat exchanger in which the coolant for cooling the engine 10 flows to heat air with the usage of coolant as a heat source. The heater core 141 is disposed on a downstream side of air flow of the evaporator 135 so as to partly cover the air passage in cross section. The heater core 141 reheats the cool air after passing through the evaporator 45. The maximum heating capacity of the heater core 141 is proportional to the temperature of coolant. The higher the temperature of coolant, the higher the maximum heating capacity of the heater core 141.

The air mix door 145 is rotatably attached to open and close on an upstream side of the heater core 141. The air mix door 145 is driven by an actuator, such as servo motor. The air mix door 145 serves as a temperature adjustment unit for adjusting a temperature of the air blown out into the vehicle compartment by adjusting the ratio of the amount of air passing through the heater core 141 and the amount of air bypassing the heater core 141 according to a stopped position of the air mix door 145. An open degree SW of the air mix door 145 is controlled between SW=0% to fully close the air passage in front of the heater core 141 and SW=100% to fully close the bypass passage bypassing the heater core 141 by the air conditioning ECU 180.

The electric heater 150 is a supplemental heater to heat warm air passing through the heater core 141. The electric heater 150 is provided at a downstream side of the heater core 141. The electric heater 150 is, for example, a PTC heater, which includes heater wires 151, 152, 153 made of nichrome wire or the like. The heater wires 151, 152, 153 are connected in parallel between a power supply Ba and ground. The heater wires 151 to 153 include switch elements SW1, SW2, SW3, respectively. The switch elements SW1, SW2, SW3 allow or stop the flow of electric current from the power supply Ba to the heater wires 151 to 153 by turning on/off of the switch elements 151 to 153. Turning on/off of the switch elements 151 to 153 is controlled by the air conditioning ECU 180.

The air conditioner control panel 160 provides various switches to operate the air conditioning unit 100A under the condition suitable to passengers (FIG. 3). For instance, the switches include an air-conditioner switch for commanding startup and stop of the refrigerant cycle 130 (e.g. the compressor 131), an air inlet selector switch for switching the air inlet mode, a temperature setting switch for setting the temperature in the vehicle compartment to a desired temperature, an air amount selector switch for switching the amount of air (off, auto, Lo, Me, Hi) blown by the blower 120, an air outlet selector switch for switching the air outlet mode, and an eco mode switch for selecting an economical mode of the air conditioning unit 100A. The air conditioning ECU 180 receives switch signals from each switch on the air conditioner control panel 160.

The sensors 171 to 176 include an inside air temperature sensor 171, an outside air temperature sensor 172, a solar radiation sensor 173, a refrigerant pressure sensor 174, a post-evaporator temperature sensor 175, and a coolant temperature sensor 176. The inside air temperature sensor 171 generates an inside temperature signal corresponding to the temperature of the air in the vehicle compartment (inside air temperature). The outside air temperature sensor 172 generates an outside air temperature signal corresponding to the temperature of the air outside the vehicle compartment (outside air temperature). The solar radiation sensor 173 generates a solar radiation signal corresponding to the solar radiation entering the vehicle interior. The refrigerant pressure sensor 174 generates a pressure signal corresponding to the high-pressure-side pressure of the refrigerant cycle 130. The post-evaporator temperature sensor 175 generates a post-evaporator temperature signal corresponding to the temperature of the air at the downstream of evaporator 135. The coolant temperature sensor 176 generates a coolant temperature signal corresponding to the temperature of the coolant (coolant temperature) flowing into the heater core 141. Each of signals generated by the sensors 171 to 176 is provided to the air conditioning ECU 180.

The air conditioning ECU 180, corresponding to the control unit, includes a microcomputer that is constructed of a CPU, a ROM, a RAM. As shown in FIG. 3, the switch signals provided from the air conditioner control panel 160 and the sensor signals provided from the sensors 171 to 176 are A/D converted from an analog form to a digital form by an input circuit in the air conditioning ECU 180, and then provided into the microcomputer. The air conditioning ECU 180 controls the operation of the air conditioning unit 100A based on various signals A/D converted, provides Engine-ON request signal to the hybrid ECU 12 (engine 10). The air conditioning ECU 180 receives information indicative of a remaining battery capacity (the battery charging capacity) from the hybrid ECU 12. The air conditioning ECU 180 can receive information indicative of an operation of a seat air conditioning unit. The air conditioning ECU 180 is supplied with electric power from an automotive battery and operates when an ignition switch of the hybrid vehicle is turned on.

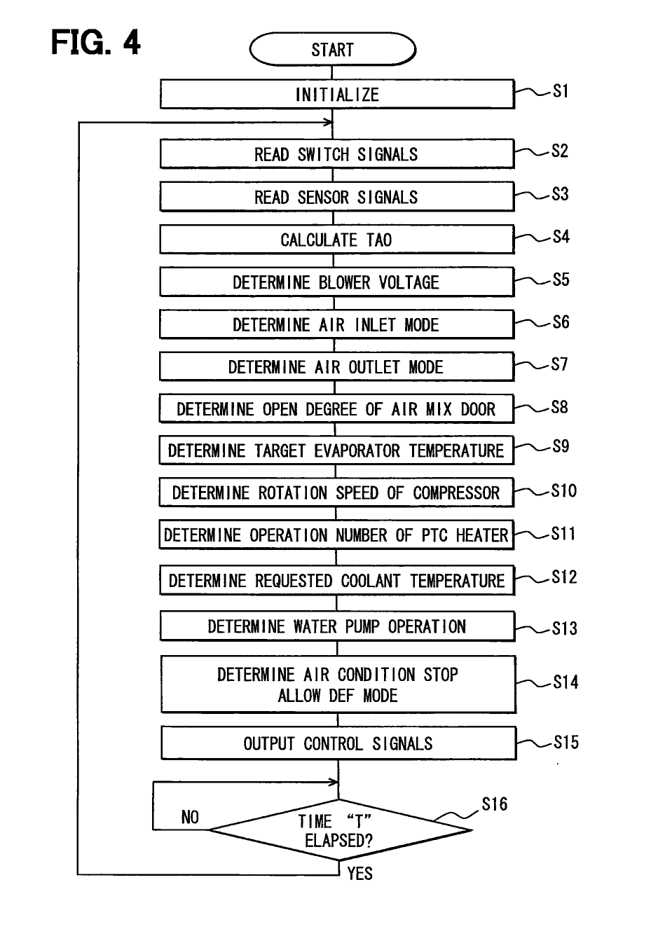

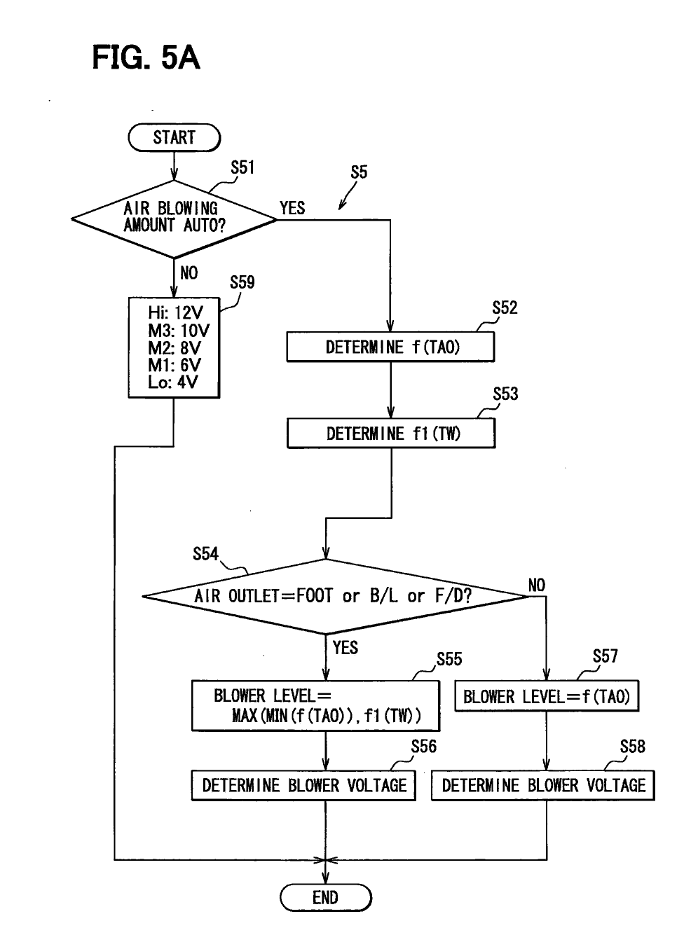

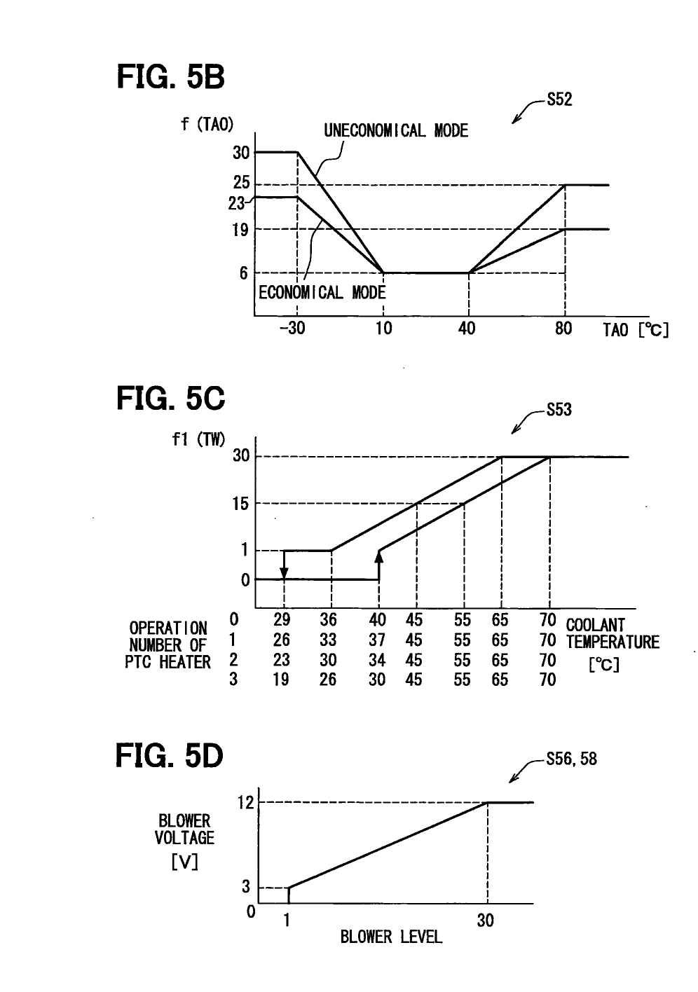

Now, control process performed by the air conditioning ECU 180 of the first embodiment will be described based on FIGS. 4 to 13. FIG. 4 is a flowchart showing a basic control process of the first embodiment performed by the air conditioning ECU 180. FIGS. 5A to 13 are subroutines of control processes of FIG. 4.

First, when an ignition switch is turned on to supply electric power to the air conditioning ECU 180, a routine shown in FIG. 4 and subroutines shown in FIGS. 5 to 13 are started to initialize at S1. Subsequently, at S2, switch signals provided from each switch of the air conditioner control panel 160 are read. At S3, sensor signals from the sensors 171 to 176 are A/D converted, and read.

At S4, a target outlet air temperature (TAO) of air blown into the vehicle compartment is calculated by using the following formula F1, which is stored in the ROM.

TAO=Kset×Tset−Kr×Tr−Kam×Tam−Ks×Ts+C (F1)

Here, Tset is a set temperature of the vehicle compartment set by the temperature setting switch, Tr is a temperature inside the vehicle compartment detected by the inside air temperature sensor, Tam is a temperature outside the vehicle compartment detected by the outside air temperature sensor, and Ts is a solar radiation amount detected by the solar radiation sensor. Furthermore, Kset, Kr, Kam and Ks are gains, and C is a constant value for correction.

At S5, a blower voltage (an air blowing amount) of the blower 120 is determined. This blower voltage determination process, is performed based on a subroutine (S51 to S58) shown in FIGS. 5A, 5B, 5C, and 5D.

First, at S51, it is determined whether the air blowing amount is automatically set. If the air blowing amount is automatically set (S51, YES), the air conditioning ECU 180 calculates a preliminary blower level f (TAO) as a criteria based on a graph stored in the ROM at S52. The blower level f (TAO) is set high when the target outlet air temperature TAO is in a high region (TAO>40° C.) or a low region (TAO<10° C.), the blower level f (TAO) is set low when the target outlet air temperature TAO is a middle region (10° C.≦TAO≧40° C.). When the eco mode switch selects the economical mode, the blower level f (TAO) is set lower than that when the eco mode switch does not select the economical mode (uneconomical mode). As a result, the power consumption of the blower is reduced, and a rate in which the temperature of the evaporator increases becomes slow in a cooling mode. As a decrease in temperature of the coolant cooling the engine 10 becomes slow in a heating mode, the air conditioning unit 100 can save electrical power during operation.

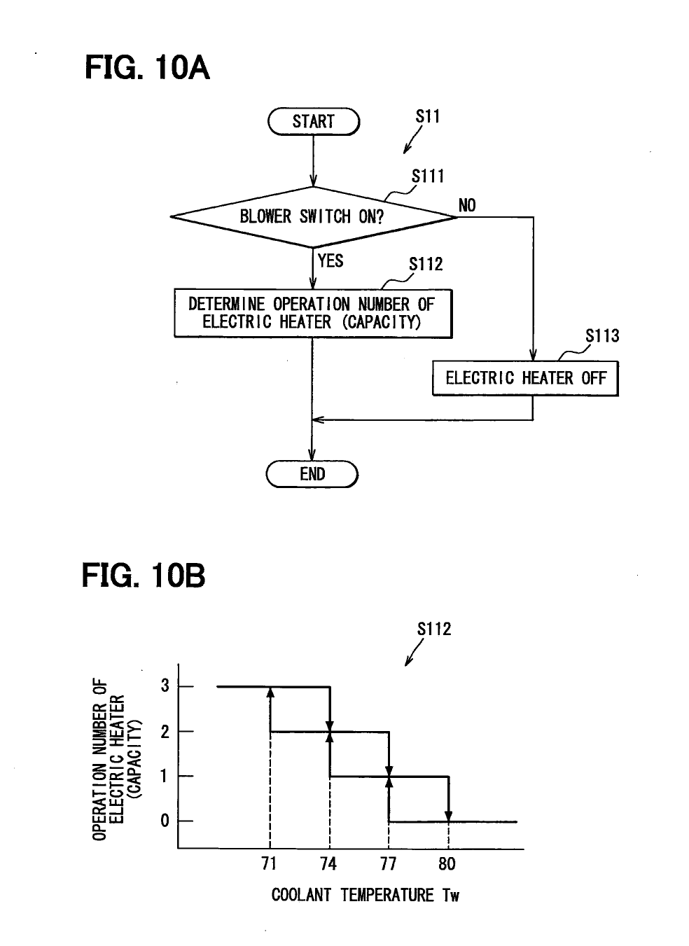

At S53, the air blowing amount f1 (TW) for warming up is calculated based on the coolant temperature TW of the coolant flowing through the heater core 141 and the operation number of PTC (S11, FIGS. 10A, 10B). At S54, it is determined whether the air outlet mode is set to one of the foot (FOOT) mode, the bi-level (B/L) mode, and the defroster (DEF) mode.

If the air outlet mode is set to one of the foot (FOOT) mode, the bi-level (B/L) mode, and the defroster (DEF) mode (S54, YES), the air conditioning ECU 180 proceeds to S55. At S55, the bigger one of the minimum value of the blower level f (TAO) and the air blowing amount f1 (TW) for warming up is selected as a blower level. At S56, the blower level selected at S55 is converted into a blower voltage based on a control map stored in the ROM.

If the air outlet mode is not set to any one of the foot (FOOT) mode, the bi-level (B/L) mode, and the defroster (DEF) mode (S54, NO), for example, if the air outlet mode is set to face (FACE) mode, the air conditioning ECU 180 proceeds to S57, and the blower level f (TAO) is selected as a blower voltage. At S58, the blower level selected at S57 is converted into a blower voltage based on a control map stored in the ROM.

If the air blowing amount is not automatically set but manually set (S51, NO), a voltage (4 voltage to 12 voltage) designed by a control map stored in the ROM is set as a blower voltage at S59.

The air conditioning ECU 180 returns to main process of FIG. 4 after S56, S58, or S59.

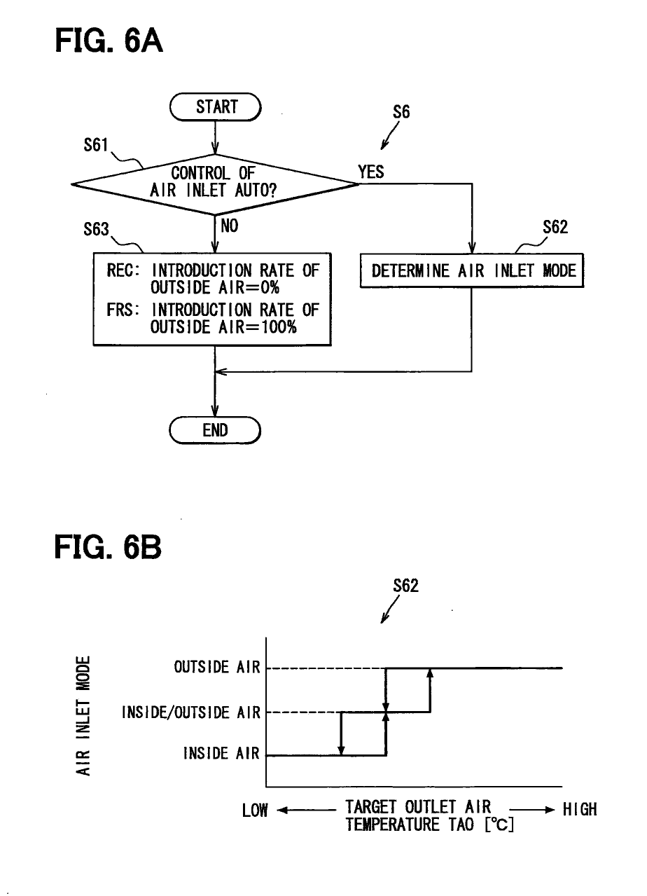

At S6, the air conditioning ECU 180 determines the air inlet mode based on the control processes shown in FIGS. 6A, 6B. That is, the air inlet mode is determined based on the target outlet air temperature (TAO) so as to determine air introduced into the air conditioning duct 110.

First, at S61, it is determined whether a control process of the air inlet mode is automatically set. If the control process of the air inlet mode is automatically set (S61, YES), the air inlet mode is determined according to the target outlet air temperature (TAO) at S62. The air inlet mode is set as the inside air circulation mode corresponding to the low target air outlet temperature, set as the inside air circulation and outside air introduction mode corresponding to the middle target air outlet temperature, and set as the outside air introduction mode corresponding to the high target air outlet temperature. If the result of the determination at S61 is not automatically set but manually set, the air inlet mode is determined according to a manual setting. In particular, the introduction rate of outside air is set to 0% when the manual setting is the inside air circulation (REC) mode. The introduction rate of outside air is set to 100% when the manual setting is the outside air introduction mode and then the air conditioning ECU 180 returns to main process of FIG. 4.

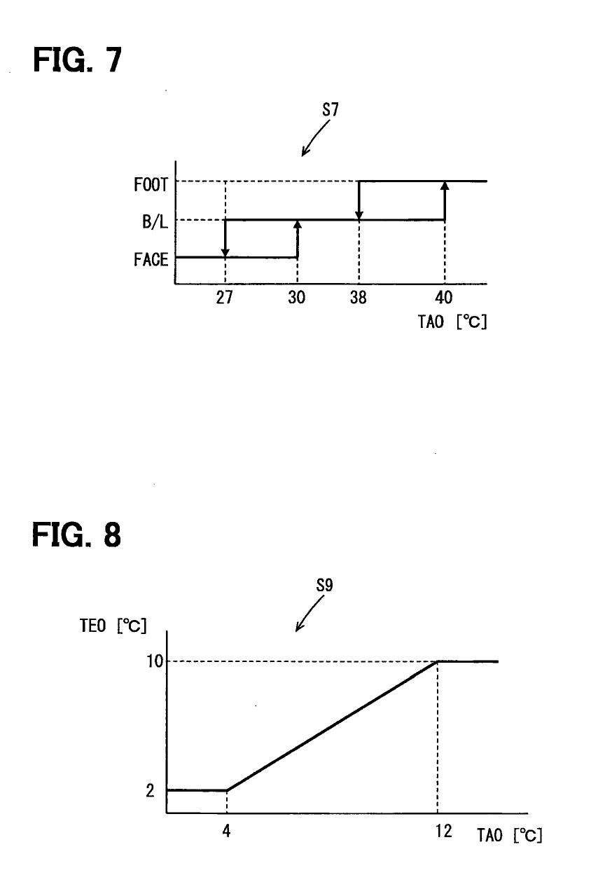

At S7, the air conditioning ECU 180 determines the air outlet mode by performing the process of FIG. 7. As shown in FIG. 7, the air outlet mode to introduce conditioned air into a vehicle compartment is determined based on the target outlet air temperature (TAO). As the TAO increases from a low to high region, the air outlet mode changes from FACE mode to bi-level (B/L) mode to foot mode.

At S8, the air conditioning ECU 180 determines a target open degree SW of the air mix door 145. The target open degree SW of the air mix door 145 is calculated by using the following formula F2, which stored in the ROM.

SW={(TAO−TE)/(TW−TE)}×100(%) (F2)

In formula F2, TAO is the target outlet air temperature calculated at S4, TE is the post-evaporator temperature detected by the post-evaporator temperature sensor 175, TW is the coolant temperature detected by the coolant temperature sensor 176.

At S9, the air conditioning ECU 180 determines the target post-evaporator temperature by performing the process of FIG. 8. As shown in FIG. 8, the target post-evaporator temperature is determined based on the target outlet air temperature TAO. The target post-evaporator temperature TEO is increased (2° C.-10° C.), as the TAO increases from a low to high temperature region (4° C.-12° C.).

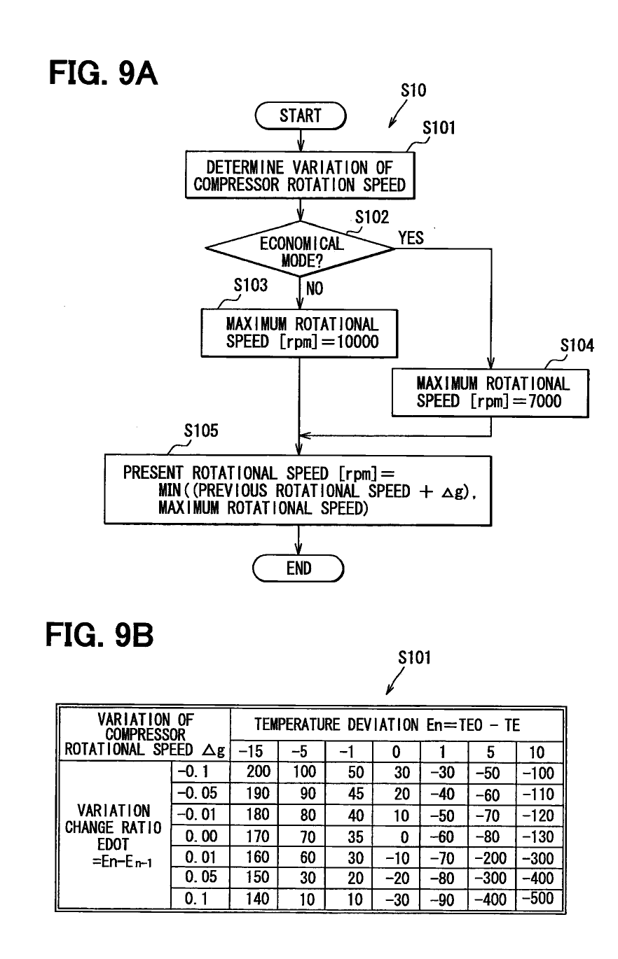

At S10, the determination process of a rotational speed of the compressor 131 (the motor 131a) is performed so that the rotational speed of the compressor 131 is determined. This determination process of a rotational speed of the compressor 131 is performed based on subroutines (S101 to S105) shown in FIGS. 9A and 9B.

First, at S101, a temperature deviation Eₙ and a deviation change ratio EDOT are calculated by using the following formula F3 and F4 stored in the ROM.

Eₙ=TEO−TE (F3)

In formula F3, TEO is the target post-evaporator temperature determined at S9 and TE is the evaporator temperature.

EDOT=Eₙ−Eₙ₋₁ (F4)

In formula F4, Eₙ₋₁ is the previous value of the temperature deviation Eₙ, where n is a natural number. As Eₙ is updated one time per second, Eₙ₋₁ is a value obtained one second prior to Eₙ.

The S101 in FIG. 9B shows relationships among, for example, the temperature deviation Eₙ, the deviation change ratio EDOT, and a variation of the rotational speed Δg. The variation of the rotational speed Δg is calculated based on the temperature deviation Eₙ and the deviation change ratio EDOT. The present rotational speed g obtained one second posterior to gₙ₋₁ is calculated by adding the rotational speed gₙ₋₁ to the variation of the rotational speed Δg.

The amount of change of the compressor rotational speed g is also calculated based on a membership function and a rule stored in the ROM by fuzzy control.

At S102, it is determined whether the eco mode switch is turned on to the economical mode. If the eco mode switch is not turned on to the economical mode (S102, NO), the maximum rotational speed is set at a first value (e.g. 10000 rpm) at S103. If the eco mode switch is turned on the economical mode (S102, YES), the maximum rotational speed is set at a second value (e.g. 7000 rpm) at S104. At S105, a sum of the previous rotational speed of the compressor and the variation of speed rotation Δg is compared with the maximum rotational speed (10000 rpm or 7000 rpm) determined at S103 or S104, and the smaller one of the two values is provided as present rotational speed.

In the economical mode, the maximum rotational speed is set at a second value (e.g. 7000 rpm), which is lower than the maximum rotational speed in the uneconomical mode (10000 rpm), so the power consumption of the compressor is restricted by lowering the maximum rotational speed in the economical mode.

At S11, calculation process of the operation number of the PTC heater (the heater wires 151 to 153) constructed of the electric heater 150 is performed and the operation number of the electric heater 150 is determined. This calculation process of the operation number of the electric heater 150 is performed based on the subroutines (S111 to S113) shown in FIGS. 10A, 10B.

At S111, it is determined whether a blower switch is turned on. In particular, it is determined whether the blower switch is set to any one of “AUTO”, “LOW”, “MIDDLE”, “HIGH”, other than “OFF”. If the blower switch is turned on at S111, the operation number of the electric heater 150 corresponding to the coolant temperature TW obtained by the coolant temperature sensor 176 is determined. As the coolant temperature TW increases from low temperature to high temperature, the operation number of the electric heater 150 is determined to decrease (the operation number decrease from 3 to 1).

If the blower switch (the air amount switch) is not turned on at S111 (if the blower switch is turned off), the electric heater 150 is set to be turned off at S113.

In this way, the operation number of the electric heater 150 is determined, and the switch element SW1, SW2, and SW3 are turned ON/OFF in response to the operation number determined. The amount of heat supplied to the warm air having passed through the heater core 141 is changed according to the operation number of electric heater 150.

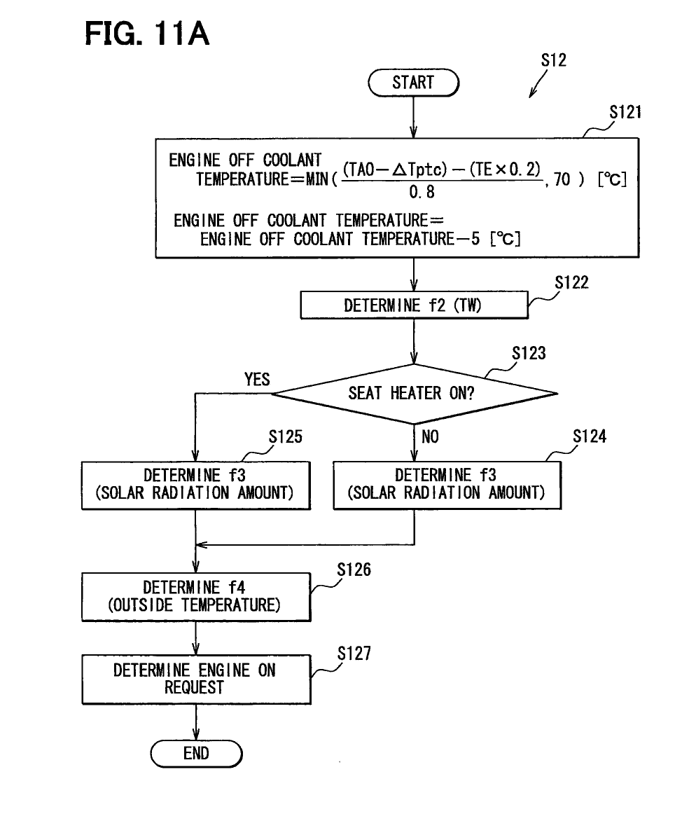

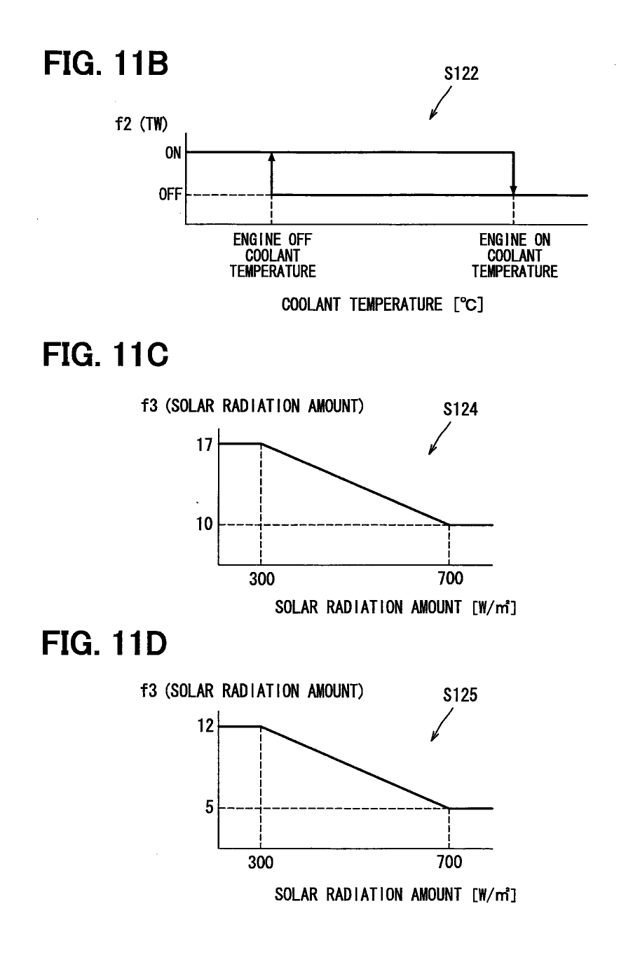

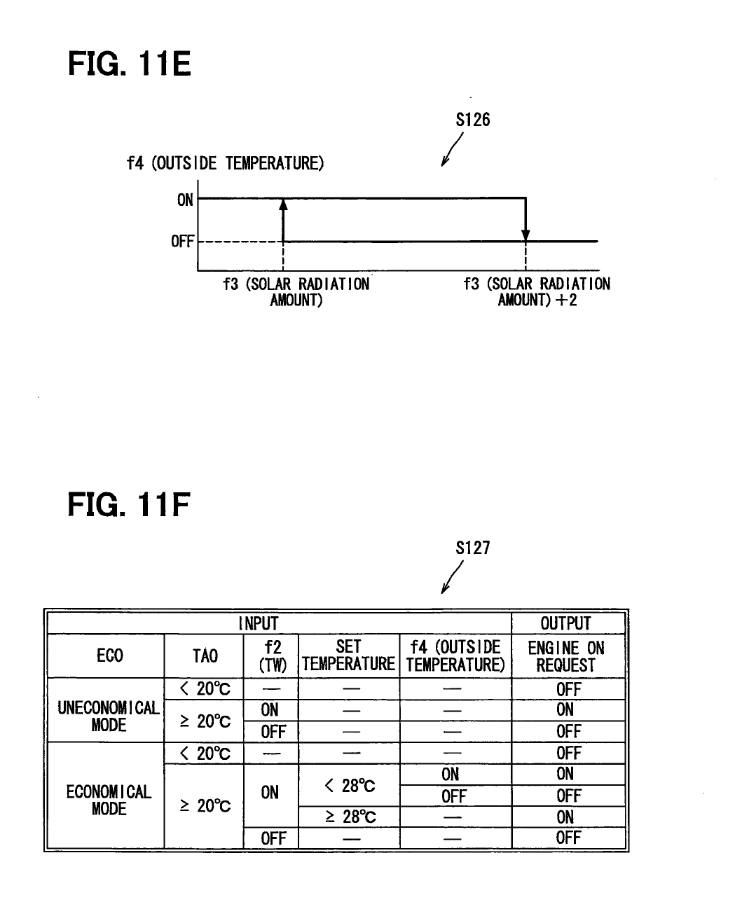

At S12, the determination process of a requested coolant temperature is performed. The requested temperature of engine coolant is determined based on the target outlet air temperature TAO so as to use engine coolant as heat source for a heating mode, antifogging properties. The determination process of the requested coolant temperature is performed based on subroutines (S121 to S127) shown in FIGS. 11A, 11B, 11C, 11D, 11E and 11F.

First, an engine-on coolant temperature and an engine-off coolant temperature are calculated as determination thresholds to determine whether the engine 10 is turned on based on the coolant temperature at S121. The engine-off coolant temperature is used to determine whether the engine 10 is turned off. The engine-on coolant temperature is used to determine whether the engine 10 is turned on.

At S121, a criterion coolant temperature TWO calculated by the following formula F5 is compared with 70° C., and the smaller one of two values is provided as the engine-off coolant temperature based on the following formula F6.

TWO={(TAO−ΔTpct)−(TE×0.2)}/0.8 (F5)

The engine-off coolant temperature=MIN(TWO,70) (F6)

In formula F5 and F6, the criterion coolant temperature TWO is a coolant temperature TW to be needed assuming the warm air before mixing become the target outlet air temperature. TAO is the target outlet air temperature, TE is the post-evaporator temperature. ΔTpct is an estimate value as the temperature rise of the outlet air temperature by the electric heater 150, and is calculated based on a graph in response to the operation number of the electric heater 150.

At S121, the engine-on coolant temperature is set as lower than the engine-off coolant temperature by predetermined value (5° C. in the first embodiment) as shown in formula F7 in order to prevent the engine 10 from turning on and off frequently.

The engine-on coolant temperature=The engine-off coolant temperature−5° C. (F7)

At S122, it is determined whether an engine-on request is required based on the coolant temperature TW. At S122, it is determined whether a preliminary engine-on request is required. In particular, an actual coolant temperature is compared with the engine-on coolant temperature and the engine-off coolant temperature. If the engine coolant temperature TW is changed from a temperature lower than the engine-on temperature to the engine-off temperature, the running of an engine 10 is temporarily determined as f2 (TW)=ON. On the other hand if the engine coolant temperature TW is in a range from a temperature higher than the engine-off temperature to the engine-on temperature, stopping the operation of the engine 10 is temporarily determined as f2 (TW)=OFF.

At S123, it is determined whether the seat air conditioning unit for warming a passenger seat is turned on (ON). If the seat air conditioning unit is not “ON” at S123, f3 (solar radiation amount), which is a criteria to determine whether an engine-on is provided, is calculated in response to the solar radiation amount at S124. The calculation is performed based on the graph of FIG. 11C. If the seat air conditioning unit is “ON” at S123, f3 (solar radiation amount) is calculated based on the graph of FIG. 11D at S125. f3 (solar radiation amount) at S125 is lower than S124.

At S126, either “ON” or “OFF” is selected for f4 (outside air temperature) based on the value of f3 (solar radiation amount) calculated at S124 or S125. At S126, “OFF” is selected at first for f4 (outside air temperature) as an initial value.

At S127, it is determined whether a final engine-on request for the engine 10 is generated. If the target outlet air temperature TAO is greater than or equal to 20 degree and f2 (TW)=ON in the uneconomical mode, the engine-on request is output. On the other hand, if the target outlet air temperature TAO is less than 20 degree or f2 (TW)=OFF in the uneconomical mode, the engine-on request is not output.

If the target outlet air temperature TAO is greater than or equal to 20 degree and f2 (TW)=ON and the set temperature Tset is less than 28 degree and f4 (outside air temperature)=ON in the economical mode, the engine-on request is output. Additionally, if the target outlet air temperature TAO is greater than or equal to 20 degree and f2 (TW)=ON and the set temperature Tset is greater than or equal to 28 degree in the economical mode, the engine-on request is output. On the other hand, if the target outlet air temperature TAO is less than 20 degree, f2 (TW)=OFF, or the set temperature Tset is less than 28 degree or f4 (outside air temperature)=OFF in the economical mode, the engine-on request is not output.

At S123, if the seat air conditioning unit is turned on, the temperature sensitivity of passengers becomes high, f3 (solar radiation amount) is set low and it becomes difficult to output the engine-on request. As a result, a minimum sense of warmth is secured and the fuel consumption improves. Additionally, the noise outside vehicle decreases, and it can make efficient use of electric power charged in vehicle battery. The higher the solar radiation amount, the harder it is to provide the engine-on request because the solar radiation amount is proportional to the temperature sensitivity of passenger. As a result, a minimum sense of warmth, a decrement of noise outside vehicle, the efficient use of electric power charged can be secured.

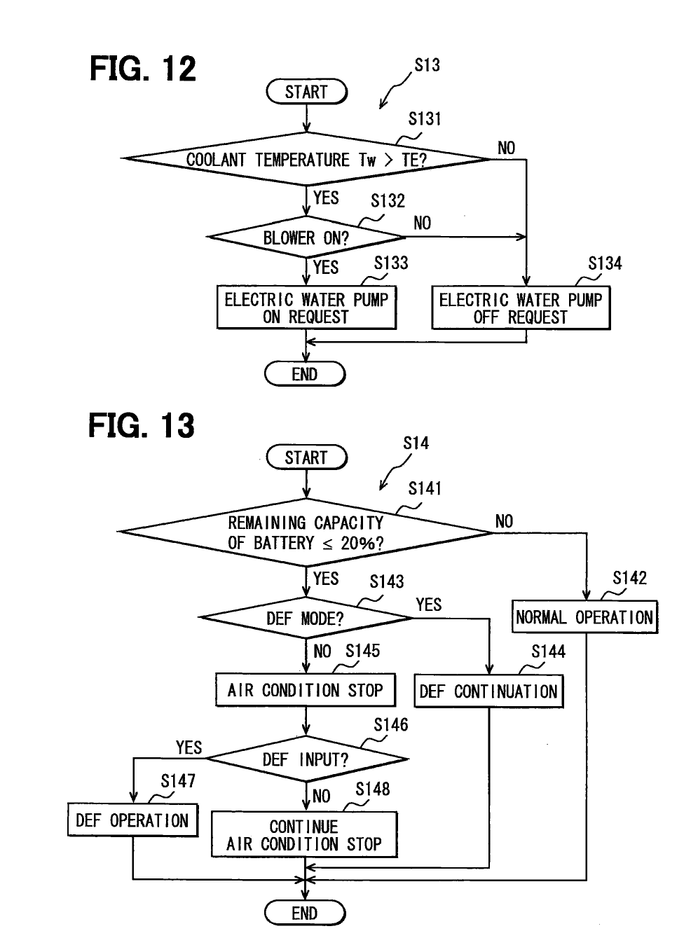

At S13 of FIG. 4, the operation determination process of a water pump 142 is performed. In the operation determination process of the water pump 142, ON/OFF of the water pump 142 is determined by using the coolant temperature TW based on subroutines (S131 to S134) shown in FIG. 12.

At S131, it is determined whether the coolant temperature TW is higher than the post-evaporator temperature TE. If it is determined that the coolant temperature TW is higher than the post-evaporator temperature TE, it is determined whether the blower 120 is turned on at S132. If it is determined that the blower 120 is turned on, the air conditioning ECU 180 proceeds to S133. At S133, the request to turn the water pump 142 on is output. On the other hand, if the result of the determination at S131 or S132 is “NO”, the air conditioning ECU 180 proceeds to S134, and the request to turn the water pump 142 off is provided.

In the operation determination process of the water pump 142, if it is determined that the coolant temperature TW is comparatively low and the coolant temperature TW is less than or equal to the post-evaporator temperature TE, the water pump 142 is turned off at S134 to prevent the outlet air temperature from decreasing when the engine coolant flows through the heater core 141.

If the coolant temperature TW is comparatively high and the blower 120 is turned off, the water pump 142 is turned off in order to restrict electric power. If the blower 120 is turned on, the request to turn the water pump 142 on is output. In this case even when the engine 10 is turned off, the heat of the engine can be used for air conditioning. Thus, the outlet air temperature increases and approach the target outlet air temperature TAO, so it prevents the compartment temperature from decreasing.

At S14, the determination process to stop air conditioning and the determination process to allow the defroster mode to operate. The process at S14 is performed based on the remaining capacity of a battery 13 and is performed based on subroutines (S141 to 5148) shown in FIG. 13.

At S141, it is determined whether the remaining capacity of the battery 13 is less than or equal to a predetermined remaining capacity. The predetermined remaining capacity is 20% of the capacity on a full charged, for example. The predetermined remaining capacity is the amount, which is set to allow the motor to drive the vehicle at a certain distance, such that even though the charge is decreasing, the vehicle would be able to reach the next charge operation for charging the battery. If it is determined that the remaining capacity of the battery 13 is greater than 20% of the capacity on a full charge (S141, NO), the air conditioning unit 100A is controlled to normally operate at S142. In particular, S16 is performed based on the determination at S2 to S13.

On the other hand, if it is determined that the remaining capacity of the battery 13 is less than or equal to 20% of the capacity on a full charged at S141, it is determined whether the air outlet mode is set to the defroster mode at S143. If it is determined that the air outlet mode is set to the defroster mode at S143, the air conditioning unit 100A continues to operate in the defroster mode at S144 without stopping the operation of the air conditioning unit 100A at S145.

However, if it is determined that the air outlet mode is not set to the defroster mode (S143, NO), the operation of the air conditioning unit 100A is stopped in order to restrict the electric power consumption of the air conditioning unit 100A at S145. After stopping the operation of the air conditioning unit 100A, it is determined whether a switch input of the air outlet mode is an input to the defroster mode at S146. If the defroster mode is input at S146, the operation in the defroster mode is allowed at S147. In particular, only if the defroster mode is requested after S145 and S146, the air conditioning unit 100A operates. On the other hand, if the defroster mode is not provided (S146, NO), the stopped state of the air conditioning unit 100A continues at S148.

As described above, in the first embodiment, if the remaining capacity of the battery 13 is less than or equal to the predetermined remaining capacity, the operation of the air conditioning unit 100A is stopped (S145) and the defroster mode can be only selected (S146) as the air outlet mode after stopping the operation of air conditioning. The power consumption for the air conditioning unit 100A is restricted and it prevents the remaining battery capacity from decreasing because the operation of the air conditioning unit 100A is stopped. As a result, it can increase mileage based on an electrical motor 11. Additionally, it ensures antifogging properties of the window (the front windshield 114b) and running safety because it can select only a defroster mode.

In the first embodiment, if the remaining capacity of the battery 13 is less than or equal to the predetermined remaining capacity and the air outlet mode is the defroster mode, the air conditioning unit 100A continues to operate in the defroster mode without stopping the operation of the air conditioning unit 100A (S143, S144). Thus, it can definitely defog the front windshield 114b and ensures a sufficient running safety.

### Second Embodiment

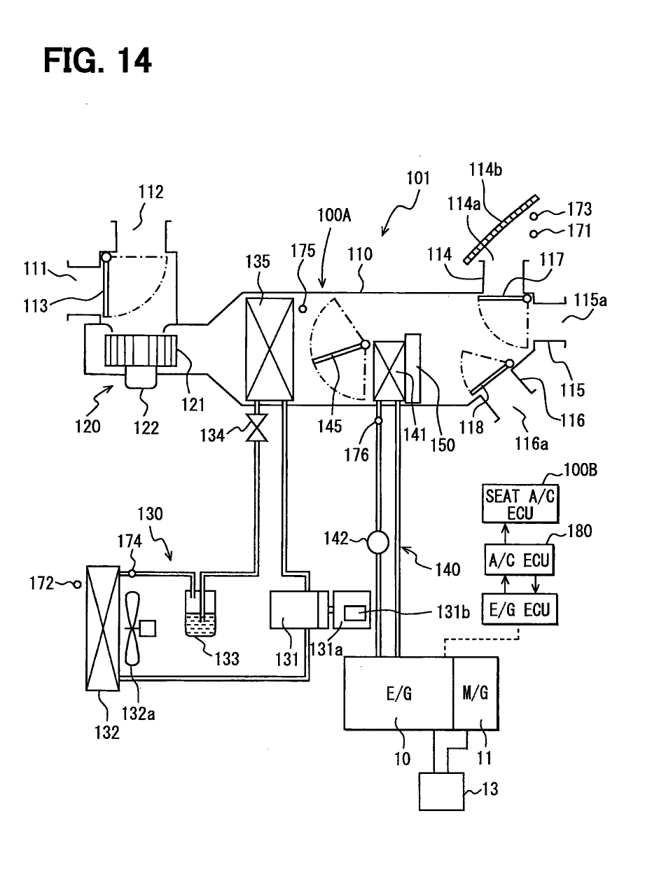

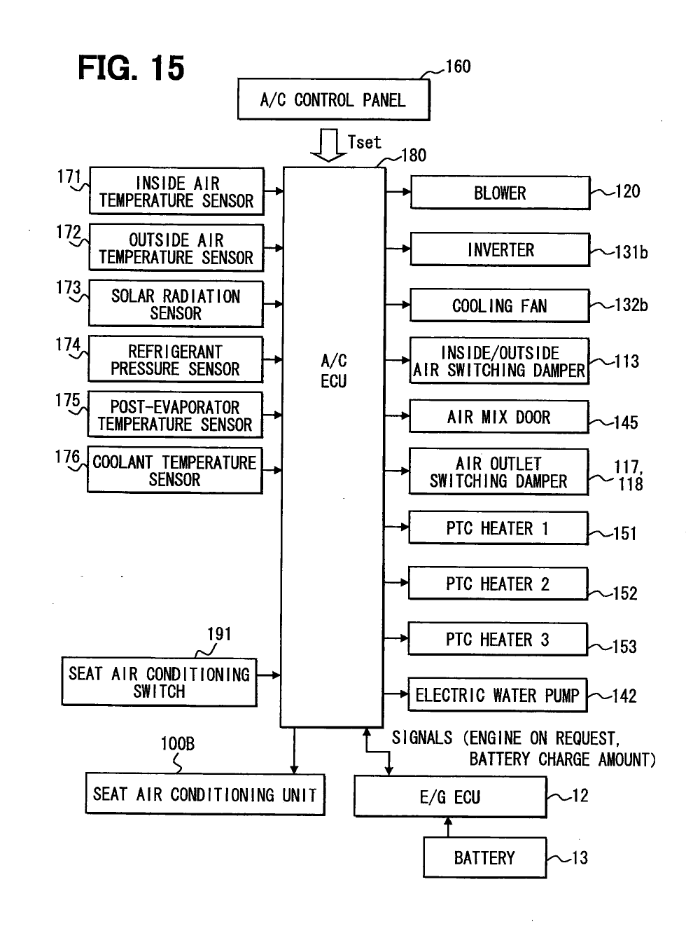

FIG. 14 and FIG. 15 show the air conditioner 101 in a second embodiment of the disclosure. The air conditioner 101 in the second embodiment includes a seat air conditioning unit 100B controlling temperature of the seat in a vehicle. The air conditioning ECU 180 controls the operation of the air conditioning unit 100A as well as the operation of the seat air conditioning unit 100B.

The seat air conditioning unit 100B is an air conditioning device for a seat for blowing warm air or cool air from holes in a seat surface toward the passenger. The seat air conditioning unit 100B includes a seat blower, Peltier element for heating or cooling the air blown from the seat blower, and a seat air conditioning switch 191. The seat air conditioning switch 191 is manually operated by a passenger so as to perform a switching between the cooling operation and heating operation of the seat air conditioning unit 100B, adjustment of the cooling level, and adjustment of the heating level. The seat air conditioning switch 191 is arranged in the air conditioner control panel 160 or adjacent to the air conditioner control panel 160.

A seat switch signal provided from the seat air conditioning switch 191 shown in FIG. 15 is A/D converted from the analog form into the digital form by the input circuit in the air conditioning ECU 180, and then provided into microcomputer. The air conditioning ECU 180 as well as air conditioning unit 100A controls the operation of the seat air conditioning unit 100B based on the seat switch signal A/D converted in addition to the operation of the air conditioning unit 100A.

Specifically, the air conditioning ECU 180 switches between heating operation and cooling operation of the blown air by switching between polarities of a voltage applied to the Peltier element. The air conditioning ECU 180 adjusts the amount of heating (or amount of heat absorption) of the blown air by adjusting the level of the voltage applied to the Peltier element. When an ignition switch is turned on to supply electrical power to the air conditioning ECU 180, a control of the seat air conditioning unit 1008 is initialized based on the seat switch signal from the seat air conditioning switch 191.

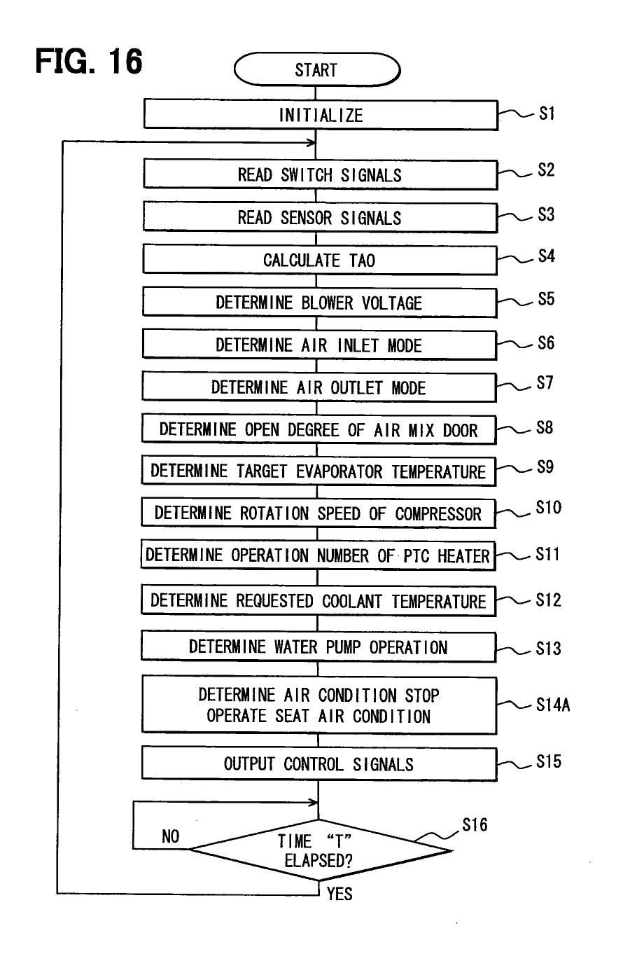

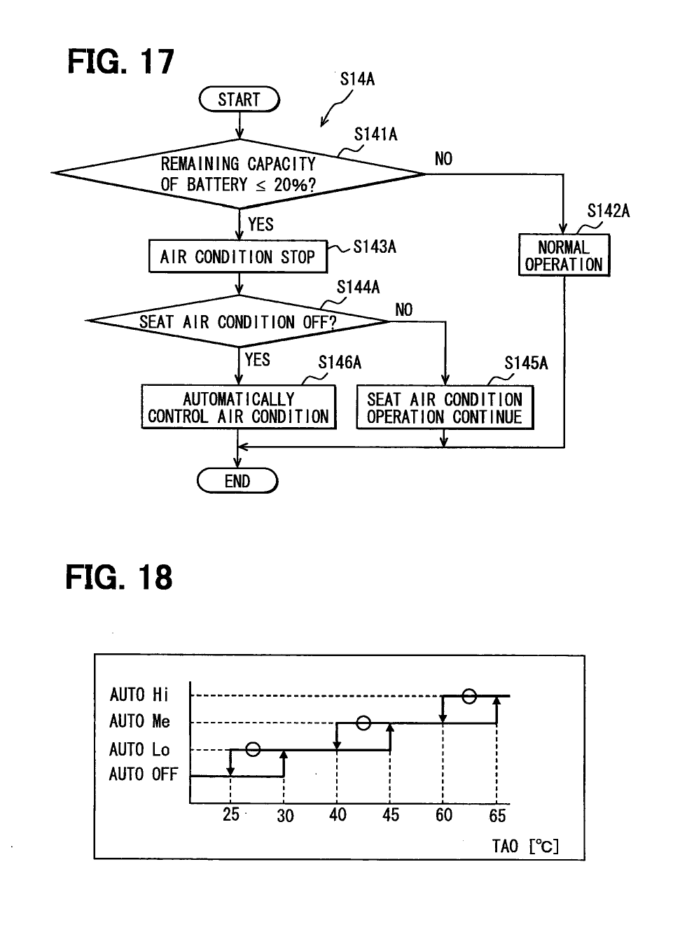

Now, control process performed by the air conditioning ECU 180 of the second embodiment will be described based on FIGS. 16 to 20. FIG. 16 is a flowchart showing a basic control process performed by the air conditioning ECU 180, according to the second embodiment, FIG. 17 is a flowchart showing a subroutine of S14A of FIG. 16. FIG. 16 is a flowchart to employ S14A instead of S14 in the flowchart described in FIG. 4 of the first embodiment.

The air conditioning ECU 180 performs S14A after performing S1 to S13 as well as the first embodiment. At S14A, the determination process to stop the operation of air conditioning and the operation process of the seat air conditioning unit 100B is performed. The processes at S14A are performed based on the remaining capacity of the battery 13 in accordance subroutines (S141A to S146A) shown in FIG. 17.

At S141A, it is determined whether the remaining capacity of the battery 13 is less than or equal to a predetermined remaining capacity. The predetermined remaining capacity is, for example, 20% of the capacity on a full charged as well as the first embodiment. If the result of the determination at S141A is “NO”, in particular, it is determined that the remaining capacity of the battery 13 is greater than 20% of the capacity on a full char, S15 is performed based on the determination at S2 to S13.

On the other hand, if it is determined that the remaining capacity of the battery 13 is less than or equal to 20% of the capacity on a full charged at S141A, the operation of the air conditioning unit 100A is stopped in order to reduce the electric power consumption due to the air conditioning unit 100A at S143A.

At S144A, it is determined whether the seat air conditioning unit 100B is stopped. If the seat air conditioning unit 100B operates (S144A, NO), the seat air conditioning unit 100B continues to operate at S145A.

A seat temperature control level corresponding to the target outlet air temperature TAO is determined as shown in FIG. 18 in order to control the operation of the seat air conditioning unit 100B. The seat temperature control level, for example, corresponds to heating levels “OFF”, “Lo”, “Me”, and “Hi”, or cooling levels “OFF”, “Lo”, “Me”, and “Hi”. In FIG. 18, the heating mode is supposed. The heating level increases in the order corresponding to “OFF”, “Lo”, “Me”, and “Hi” as the target outlet air temperature TAO increases.

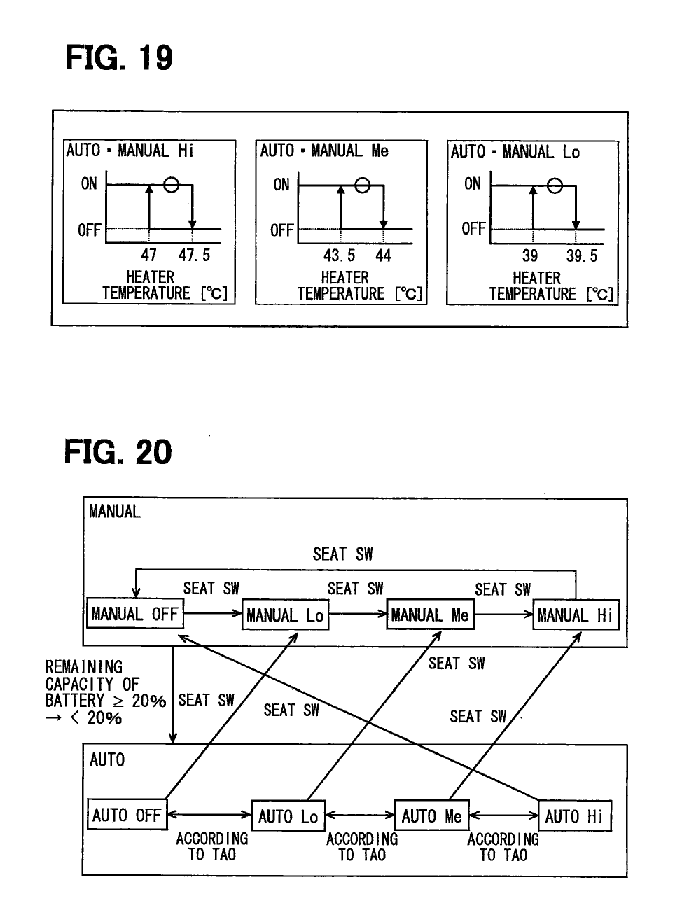

The level of the voltage applied to the Peltier element is adjusted as shown in FIG. 19 in order to obtain the heating capacity (heating temperature) of the Peltier element corresponding to a set heating level (Hi, Me, Lo). For example, if the set heating level is “Hi”, a voltage is applied to the Peltier element until the heating temperature increases from low temperature to 47.5° C., and a voltage is not applied to the Peltier element until the heating temperature decreases from high temperature to 47.5° C. As a result, the heating temperature corresponding to the heating level “Hi” is obtained. The case of the heating level “Me” or “Lo” is set similarly to that of the heating level “Hi”.

Returning to the FIG. 17, if it is determined that the seat air conditioning unit 100B is stopped at S144A, the seat air conditioning unit 100B is automatically controlled to operate at S146A.

In the manual control of the seat air conditioning unit 100B as shown in FIG. 20, the heating level is switched among “manual off”, “manual Lo”, “manual Me”, “Manual Hi”, and “Manual off” in this order every time passenger inputs the seat air conditioning switch 191, and the seat air conditioning unit 100B is operated to have the set heating level.

On the other hand, in the automatic control performed when the present remaining capacity of the battery is less than 20% of the capacity on a full charged and the seat air conditioning unit 100B is stopped, each heating level (“OFF”, “Lo”, “Me”, and “Hi”), as described in FIG. 18, is determined based on the target outlet air temperature TAO, and the seat air conditioning unit 100B is operated to have the set heating level.

As stated above, in the second embodiment, if the remaining capacity of the battery 13 is less than or equal to the predetermined remaining capacity, the operation of the air conditioning unit 100A is stopped (S143A) and the seat air conditioning unit 100B is started to operate when the seat air conditioning unit 100B is in the stopped state (S144A, S146A). In this way, the air conditioning unit 100A with high electric power consumption is stopped and only the air conditioning unit 100B with low electric power consumption is operated. It can restrict power consumption for the air conditioner and prevent the remaining capacity of the battery 13 from decreasing. As a result, it can increase mileage due to the electrical motor 11. Additionally, it can minimize deteriorating the temperature sensitivity of passengers.

### Third Embodiment

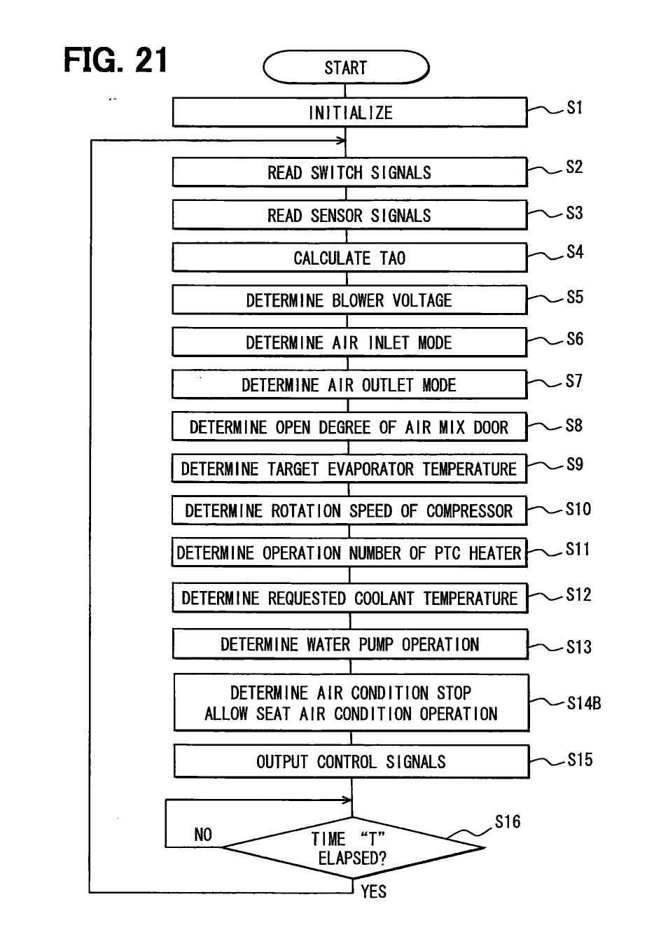

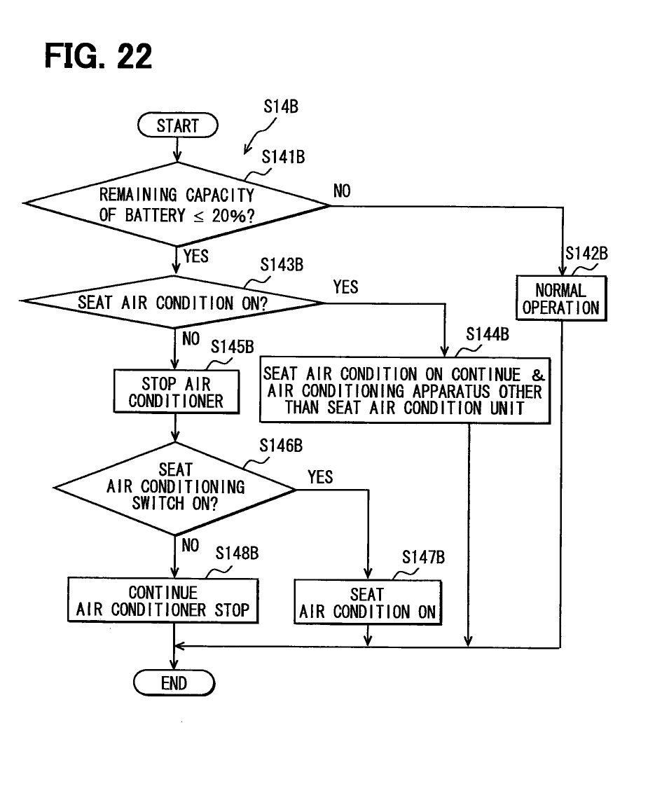

FIG. 21 and FIG. 22 show a third embodiment of the disclosure. The third embodiment is modifications to the control process of the air conditioner 101 in the second embodiment.

Control process by the air conditioning ECU 180 of the third embodiment will be described based on FIGS. 21 and 22. FIG. 21 is a flowchart showing a basic control process performed by the air conditioning unit ECU 180, according to the third embodiment. FIG. 22 is a subroutine showing a detailed operation of S14B of FIG. 21. FIG. 21 is a flowchart to employ S14B instead of S14A in the flowchart described in FIG. 16 of the second embodiment.

The air conditioning ECU 180 performs S14B after performing S1 to S13 as well as the first and the second embodiment. At S14B, the determination process to stop the operation of air conditioning and the operation process allowing the seat air conditioning unit 100B to start are performed. The processes at S14B are performed based on the remaining capacity of the battery 13 and subroutines (S141B to S148B) shown in FIG. 22.

At S141B, it is determined whether the remaining capacity of the battery 13 is less than or equal to a predetermined remaining capacity. The predetermined remaining capacity is, for example 20% of the capacity on a full charged, similarly to the first embodiment. If it is determined that the remaining capacity of the battery 13 is greater than 20% of the capacity on a full charge (S141B, NO), the air conditioning unit 100A is controlled to normally operate at S142B. In particular, S16 is performed based on the determination of the S2 to S13.

On the other hand, if it is determined that the remaining capacity of the battery 13 is less than or equal to 20% of the capacity on a full charged at S141B, it is determined whether or not the seat air conditioning unit 100B is in an operation state at S143B. If the result of the determination at S143B is the YES, the seat air conditioning unit 100B continues to operate at S144B. Additionally, an operation of air conditioning apparatus (the air conditioning unit 100A) other than the seat air conditioning unit 100B is stopped.

If it is determined that the seat air conditioning unit 100B is in the stopped state (S143B, NO), the operation of the air conditioning unit 100A is stopped (S145B).

It is determined whether the seat air conditioning switch 191 is turned on at S146B after S145B. If the air conditioning switch 191 is turned on, the seat air conditioning unit 100B operates at S147B. If the air conditioning switch 191 is not turned on, the stopped state of the air conditioning unit 100A continues at S148B.

As stated above, in the third embodiment, if the remaining capacity of the battery 13 is less than or equal to the predetermined remaining capacity, the temperature control is enabled by the seat air conditioning unit 100B according to the input from the air conditioning switch 191 (S146B, S147B), while stopping the operation of the air conditioning unit 100A (S145B). In this way, the air conditioning unit 100A with high electric power consumption is stopped and only the air conditioning unit 100B with low electric power consumption is operated. It can restrict power consumption for the air conditioner and prevent the remaining capacity of the battery 13 from decreasing. As a result, it can increase mileage due to an electrical motor 11. Additionally, it can minimize worsening the temperature sensitivity of passengers.

### Fourth Embodiment

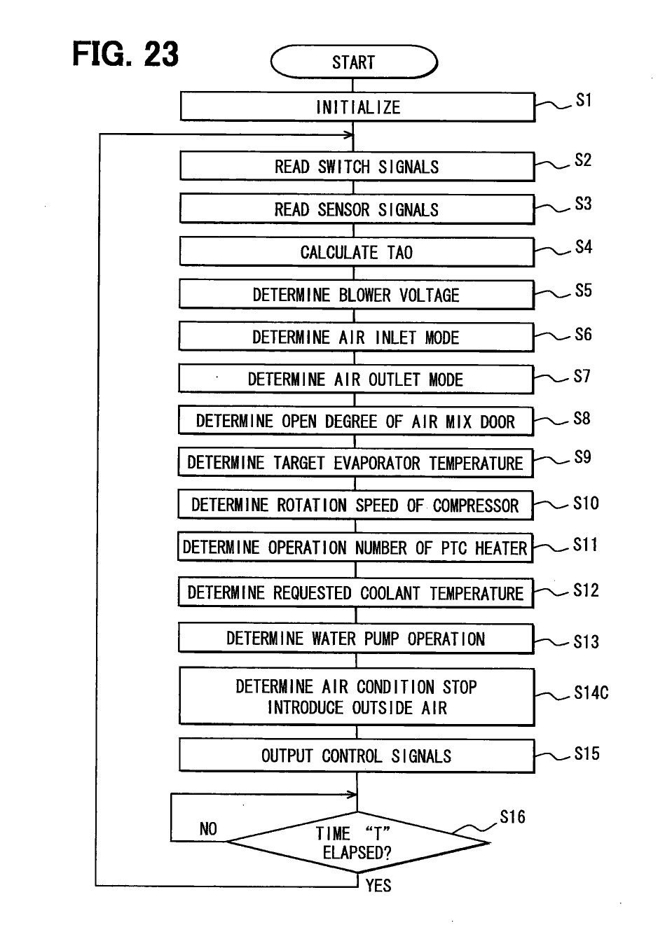

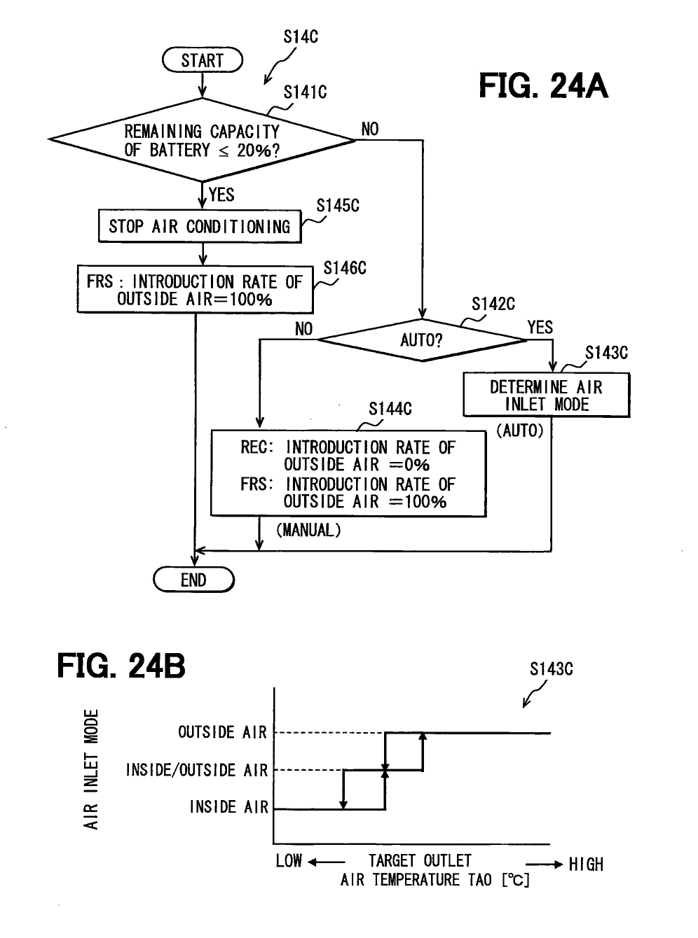

FIG. 23 and FIGS. 24A, 24B show a fourth embodiment of the disclosure. The fourth embodiment is modifications to the control process of the air conditioner 101 in the first embodiment.

Control process of the air conditioning ECU 180 of the fourth embodiment will be described based on FIGS. 23, 24A and 24B. FIG. 23 is a flowchart showing a basic control process performed by the air conditioning unit ECU 180, according to the fourth embodiment. FIGS. 24A and 24B are subroutines showing a detailed operation of S14C of FIG. 23. FIG. 23 is a flowchart to employ S14C instead of S14 in the flowchart described in FIG. 4 of the first embodiment.

The air conditioning ECU 180 performs S14C after performing S1 to S13 similarly to the first to the third embodiment. At S14C, the determination process to stop the operation of air conditioning and the operation process to introduce outside air is performed. The processes at S14C are performed based on the remaining capacity of the battery 13 and subroutines (S141C to S146C) shown in FIGS. 24A, 24B.

At S141C, it is determined whether or not the remaining capacity of the battery 13 is less than or equal to a predetermined remaining capacity. The predetermined remaining capacity is 20% of the capacity on a full charged as well as the first embodiment. If the result of the determination at S141C is “NO”, that is, it is determined that the remaining capacity of the battery 13 is greater than or equal to 20% of the capacity on a full charge, the air conditioning unit 100A is controlled to normally operate and the air inlet mode of the air conditioning unit 100A is switched based on S142C to S144C. The control process of S142C to S144C is the same as the control process of S51 to S63 described in the FIGS. 6A, 6B of the first embodiment.

On the other hand, if it is determined that the remaining capacity of the battery 13 is less than or equal to 20% of the capacity on a full charged at S141C, the operation of the air conditioning unit 100A is stopped in order to reduce the electric power consumption due to the air conditioning unit 100A at S145C. At S146C, the outside air introduction (FRS) mode is selected as the air outlet mode, and the introduction rate of outside air is set to 100%.

As stated above, in the fourth embodiment, if the remaining capacity of the battery 13 is less than or equal to the predetermined remaining capacity, the outside air introduction (FRS) mode is switched as the air outlet mode (S146C), while stopping the operation of the air conditioning unit 100A (S145C). In this way, the operation of air conditioning by air conditioning unit 100A is stopped. As a result, it can reduce power consumption for the air conditioning unit 100A and prevent the remaining capacity of the battery 13 from decreasing. Therefore, it can increase mileage due to the electrical motor 11. Additionally, it can minimalize the possibility to fog a window and restrict the temperature rise in the vehicle compartment by switching the air outlet mode to the outside air introduction mode.

### Other Embodiments

Although the present disclosure has been fully described in connection with the preferred embodiments thereof with reference to the accompanying drawings, it is to be noted that various changes and modifications will become apparent to those skilled in the art. For example, in the example of each of the above described embodiments, a seat air conditioning control of the air conditioning unit 100B has been mainly described in the case of heating. However, the seat air conditioning control can be applied to the cooling in the summer season.

In the above described embodiments, as be explained, both of the air conditioning unit 100A and the seat air conditioning unit 100B are controlled by the air conditioning ECU 180 in the air conditioner 101. However, the disclosure is not limited thereto. A dedicated seat ECU, which can receive various signals and calculated results between the air conditioning ECU 180 and the dedicated seat ECU, may be arranged. The air conditioning ECU 180 may control the air conditioning unit 100A, and the dedicated seat ECU may control the seat air conditioning unit 100B.

The air conditioners 100, 101, as be explained, have been applied to the hybrid vehicle. However, the disclosure is not limited thereto. The air conditioner 100, 101 may be applied to an electric vehicle equipped with only the motor 11 without the engine 10.

What is claimed is:

1. An air conditioner for a vehicle equipped with a battery for supplying electric power to a motor for driving the vehicle, the air conditioner comprising:
an air conditioning unit performing air-conditioning in a passenger compartment; and
a control unit controlling operation of the air conditioning unit and setting an air outlet mode among multiple air outlet modes including a defroster mode in which air conditioned by the air conditioning unit flows forward a front windshield of the vehicle, wherein
the control unit stops the operation of the air conditioning unit in an air outlet mode other than the defroster mode and is capable of only setting a defroster mode when a remaining capacity of the battery is less than or equal to a predetermined remaining capacity.

2. The air conditioner of claim 1, wherein
the control unit continues the operation of the air conditioning unit in the defroster mode without stopping the operation of the air conditioning unit when the remaining capacity of the battery is less than or equal to the predetermined remaining capacity and the air outlet mode is the defroster mode.

3. An air conditioner for a vehicle equipped with a battery for supplying electric power to a motor for driving the vehicle, the air conditioner comprising:
an air conditioning unit performing air conditioning in a passenger compartment;
a seat air conditioning unit adjusting a temperature of a seat of the vehicle; and
a control unit that controls operation of the air conditioning unit and the seat air conditioning unit, wherein
the control unit operates the seat air conditioning unit while stopping operation of the air conditioning unit when a remaining capacity of the battery is less than or equal to a predetermined value.

4. An air conditioner for a vehicle equipped with a battery for supplying electric power to a motor for driving the vehicle, the air conditioner comprising:
an air conditioning unit performing air conditioning in a passenger compartment;
a seat air conditioning unit adjusting a temperature of a seat of the vehicle; and
a control unit including a seat air conditioning switch to determine whether the seat air conditioning unit operates, and controlling operation of the air conditioning unit and the seat air conditioning unit, wherein
the control unit operates the seat air conditioning unit to control temperature of the seat while stopping operation of air-conditioning when a remaining capacity of the battery is less than or equal to a predetermined value and the seat air conditioning unit is turned on.

5. An air conditioner for a vehicle equipped with a battery for supplying electric power to a motor for driving the vehicle, the air conditioner comprising:
an air conditioning unit performing air conditioning in a passenger compartment; and
a control unit controlling operation of the air conditioning unit, wherein
the control unit controls an air introduction mode between an outside air introduction mode in which air outside of the passenger compartment is introduced into the air conditioning unit and an inside air circulation mode in which air inside the passenger for compartment is introduced, and
the control unit switches to the outside air introduction mode while stopping operation of the air conditioning unit when a remaining capacity of the battery is less than or equal to a predetermined value.

6. The air conditioner of claim 1, wherein
the vehicle is an electric vehicle equipped with the motor which drives the vehicle without an engine for driving the vehicle.
